(19) United States
(12) Patent Application Publication
(10) Pub. No.: US 2011/0228089 A1
(43) Pub. Date: Sep. 22, 2011

(54) METHOD FOR DETECTING VEHICLE LIGHTS AND RETROREFLECTORS WITH A CAMERA SYSTEM

(75) Inventor: Carlos Almeida, Lindau (DE)

(73) Assignee: ADC Automotive Distance Control Systems GmbH, Lindau (DE)

(21) Appl. No.: 13/131,376

(22) PCT Filed: Nov. 23, 2009
(86) PCT No.: PCT/DE09/01645

§ 371 Date: May 26, 2011

(30) Foreign Application Priority Data
Nov. 28, 2008 (DE) 10 2008 059 630.2

(51) Int. Cl. H04N 7/18

(52) U.S. Cl. 348/148; 348/E07.085

(57) ABSTRACT

A method is disclosed for distinguishing between approaching vehicle lights (VL) and retroreflectors (R) in the dark, which are recorded as light surfaces by an image recording device oriented towards the surroundings of a vehicle. The image recording device records at least one image of the vehicle surroundings. The image is evaluated by an image processing unit. Light surfaces present on the image are analyzed. A decision is then taken as to whether the light surface is a vehicle light (VL) or a retroreflector (R). Light surfaces whose optical interaction with other objects is shown in the image are identified as vehicle lights (VL).

### CROSS REFERENCE TO RELATED APPLICATIONS

This application is the U.S. National Phase Application of PCT/DE2009/001645, filed Nov. 23, 2009, which claims priority to German Patent Application No. 10 2008 059 630.2, filed Nov. 28, 2008, the contents of such applications being incorporated by reference herein.

### FIELD OF THE INVENTION

The invention relates to a method for distinguishing between approaching vehicle lights and retroreflectors in the dark in the field of automatic light control in motor vehicles.

### BACKGROUND OF THE INVENTION

The detection of vehicles in the night is in particular required with an automatic light control in a vehicle. It is the object of an automatic light control to control the brightness and/or direction of the own vehicle headlights in such a manner that other road users are not blinded.

An important feature for detecting vehicles by means of a camera in the dark is the vehicle lighting of approaching vehicles, which is displayed in the camera image by dots of high intensity.

WO 2008/064621 A1, which is incorporated by reference, shows a method for detecting reflectors and vehicle lights with a camera sensor system in the vehicle surroundings. For this purpose, an image sequence of the vehicle surroundings is recorded. At least one light spot in the image sequence is tracked. The intensity of the light spot in the image sequence is determined and analyzed. Light spots above a first threshold value are detected as vehicle lights and light spots below a second threshold value as reflectors.

EP 1837803 A2, which is incorporated by reference, shows a method for detecting vehicle front lights, rear lights and street lighting. A classifier is proposed, which is trained to then distinguish a street lighting from reflectors e.g. on the basis of a Gaussian intensity distribution in the camera image.

The distinction of vehicles and retroreflectors is difficult in many cases, since the characterizing classifier features for these two classes strongly resemble each other in some situations, resulting in misclassifications.

### SUMMARY OF THE INVENTION

An object of the invention is to indicate a method, which offers an increased reliability of the distinction between approaching vehicle lights and retroreflectors.

This object is achieved by a method for distinguishing between approaching vehicle lights (VL) and retroreflectors (R) in the dark, which are recorded as light surfaces by an image recording device oriented towards the surroundings of a vehicle, wherein the image recording device records at least one image of the vehicle surroundings, the image is evaluated by an image processing, light surfaces present on the image are analyzed, a decision is taken, as to whether the light surface is a vehicle light (VL) or a retroreflector (R), wherein light surfaces, whose optical interaction with other objects is shown in the image, are identified as vehicle lights.

The method according to aspects of the invention for distinguishing approaching vehicle lights and retroreflectors in the dark, which are recorded as light surfaces by an image recording device oriented towards the surroundings of a vehicle, comprise the following steps.

The image recording device, which is an analogue or a digital camera system, records at least one image of the vehicle surroundings. The image is evaluated by an image processing unit. Light surfaces present on the image are analyzed. It is the object of the analysis to determine optical interaction of light sources with other objects in the image.

For example the light of an approaching vehicle is diffused at particles such as dust or pollen or at water droplets found in the air. This leads in the image to an area surrounding the light source, which is brighter than the background. The intensity of this area decreases continuously starting from the edge of the light source up to the level of the background brightness.

Another example of an optical interaction is the reflection of the vehicle lights at the road surface. Thus an area below the vehicle lights results in the image, in which there are light surfaces, which correspond to the reflected vehicle lights.

Based on the analysis a decision is taken as to whether the light surface is a vehicle light or a retroreflector. If results of an optical interaction of a light source with other objects are shown, then the light surface on the image is associated a vehicle headlight. However, if no interaction with other objects is shown, then this light surface is associated to a retroreflector. A retroreflector effects a reflection, in which the radiation is reflected in directions, which are approximately opposed to the illuminating direction, this type of reflection being largely independent of the illumination. In particular traffic signs, reflector posts and road markings are usually embodied as retroreflectors.

In accordance with a preferred example of embodiment light surfaces, which are reflected in the image on the road surface, are identified as vehicle lights. Retroreflectors show almost no reflection at the road surface. Retroreflectors produce light surfaces in the image, if they are illuminated by the headlights of the own vehicle. Due to the position and the arrangement of the retroreflectors and the directed return beam direction of the light by the retroreflectors there is no reflection at the street surface.

In accordance with a further preferred example of embodiment the spatial course of the intensity of light surfaces is analyzed. The intensity course can be preferably analyzed in direction towards the horizontal image axis.

With vehicle lights the diffusion, diffraction or reflection at particles in the air such as dust or pollen or at water droplets leads to an area in the image surrounding the light surface, which is brighter than the background. The intensity of this area decreases gradually and/or continuously starting from the edge of the light source up to the level of the background brightness.

Retroreflectors show in the image as clearly defined surfaces with a high contrast between light surface and background. The spatial course of the intensity is characterized by unsteady and/or rapid increases or decreases at the edge area. This is caused by the fact that retroreflectors reflect only directed in direction towards the headlights of the own vehicle and thus towards the image recording device.

The gradient (spatial derivative) of the intensity in an image direction is preferably calculated in the area of a light surface. With a nearly constant course of the gradient of the intensity in an area around the edge of a light surface the latter is identified as vehicle light. With a narrow and distinct maximum of the gradient of the intensity in an area around the edge of a light surface the latter, however, is identified as retroreflector.

According to a further embodiment, the method can be used for verification of a first classification according to any classification method. For this purpose, light surfaces are first classified as vehicle lights and/or retroreflectors e.g. on the basis of the intensity. This first classification is verified by the method described here. This verification increases the reliability of a first classification and can correct misclassifications if necessary.

The invention includes an apparatus for distinguishing between retroreflectors and vehicle lights in the dark in the surroundings of a vehicle. The apparatus comprises an image recording device and an evaluation unit, which evaluates the image data detected by the image recording device and which uses for this purpose one of the described methods.

An advantage of the invention is an increased reliability of the classification. Compared to the tracking methods the method according to the invention offers the advantage that classification can take place on the basis of one single image. Thus, the method is fast. If an image sequence is analyzed by the method according to the invention, then the reliability of the distinction between vehicle lights and retroreflectors is further optimized.

### BRIEF DESCRIPTION OF THE DRAWINGS

The invention is best understood from the following detailed description when read in connection with the accompanying drawings. Included in the drawings is the following figures:

FIGS. 1a-1b show images of an approaching vehicle.

FIG. 2 shows an image with a retroreflector at the roadside.

FIG. 3 shows the spatial intensity course of a vehicle light and a retroreflector.

### DETAILED DESCRIPTION OF THE PREFERRED EMBODIMENTS

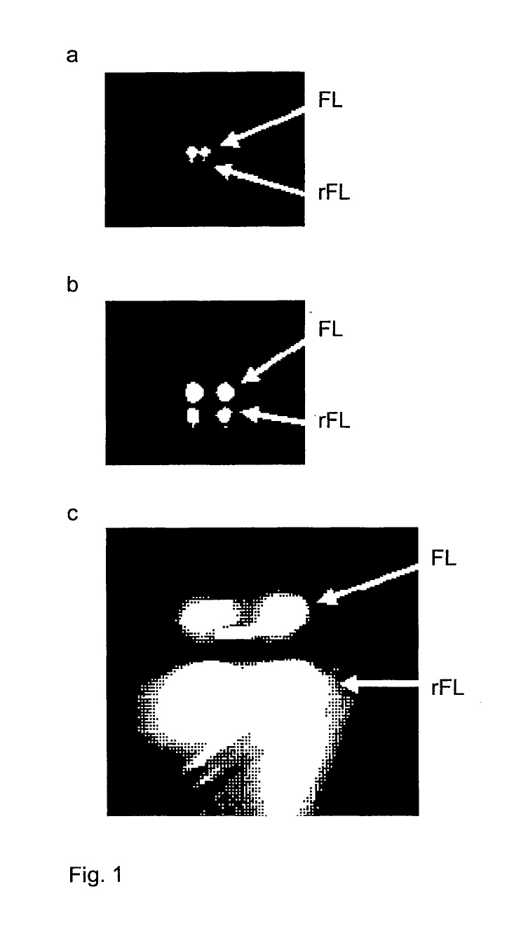

On the images in FIGS. 1a, 1b and 1c the lights of an approaching vehicle (VL) in the far, medium and close range can be detected as a pair of light surfaces with an increasing size. Below the vehicle lights (VL) a further pair of light surfaces is to be detected. These light surfaces result from a reflection of the vehicle lights at the road surface (rVL). The appearance of reflections of light surfaces at the road surface (rVL) in this embodiment is the criterion for the fact that the light source of the light surfaces are vehicle lights (VL). For supplementing the criterion that the reflected light surfaces (rVL) appear below the vehicle lights (VL), the position of the road surface can be determined and provided for example by a lane assistant. Thus it can be evaluated advantageously whether the light surfaces, which are below vehicle lights (VL), are in fact reflections at the road surface (rVL).

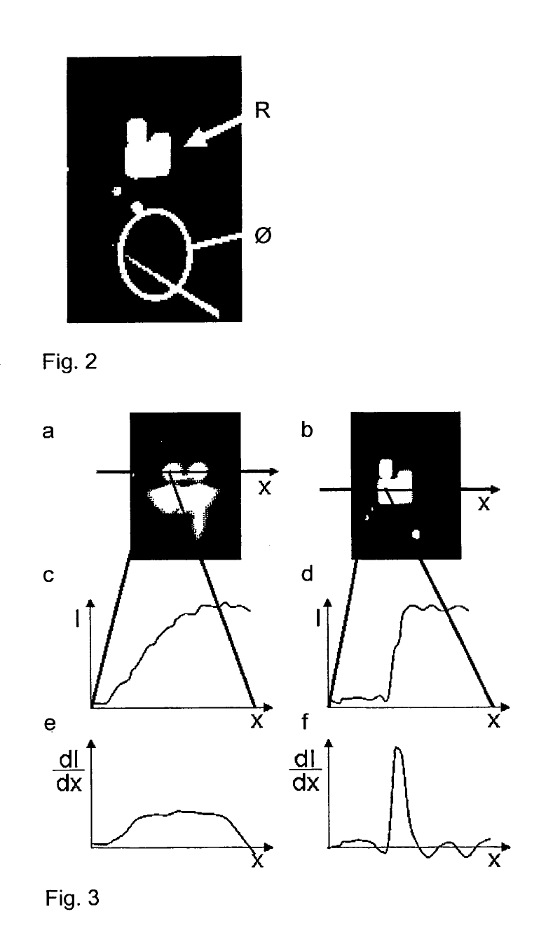

On the image in FIG. 2 a retroreflector (R) is to be detected as light surface at the roadside. Below the retroreflector (R) no reflection is to be detected on the road (Ø). This is due to the fact that the retroreflector (R) is no active light source, but is illuminated by the headlights of the vehicle and reflects this light in directed manner.

In the images and diagrams in FIG. 3 the spatial course of the intensity I(x) at the edge of light surfaces is illustrated and analyzed. The image in FIG. 3a corresponds to that represented in FIG. 1c. By the light surface of the vehicle light (VL) of an approaching vehicle the course of the intensity I(x) in an area around the edge of the light surface of the vehicle light (VL) is analyzed in x-direction, which in this example of embodiment corresponds to the horizontal image axis. In FIG. 3c the intensity course I(x) of the area defined in FIG. 3a is shown. The gradual, continuous increase of the intensity (I) can be detected, which extends nearly on the entire selected area. In FIG. 3e the spatial derivative dI/dx of the intensity in x-direction, i.e. the intensity gradient for the intensity course according to FIG. 3c is shown. Here, the continuous increase of the intensity I(x) at the nearly constant gradient dI/dx in the central area can be detected.

The image in FIG. 3b can be compared to that represented in FIG. 2 and shows a retroreflective traffic sign (R). In FIG. 3d the intensity course I(x) of the area defined in FIG. 3b around the area of the light surface of the retroreflector (R) is shown. The rapid increase of the intensity (I) at the edge of the retroreflector (R) can be detected. The human eye realizes this as a significant contrast in the image in FIG. 3b between the dark background and the clearly defined reflector (R). In FIG. 3f the intensity gradient dI/dx for the intensity course from FIG. 3d is shown. Here, the rapid increase of the intensity I(x) at the narrow and distinct maximum of the gradient dI/dx can be detected.

1.-6. (canceled)

7. A method for distinguishing between approaching vehicle lights and retroreflectors in the dark, which are recorded as light surfaces by an image recording device oriented towards the surroundings of a vehicle, wherein
the image recording device records at least one image of the vehicle surroundings,
the image is evaluated by image processing,
light surfaces present on the image are analyzed,
a decision is made, as to whether the light surface is a vehicle light or a retroreflector, wherein light surfaces whose optical interaction with other objects is shown in the image are identified as vehicle lights.

8. A method according to claim 7, wherein light surfaces, which are reflected in the image on a road surface, are identified as vehicle lights.

9. A method according to claim 7, wherein light surfaces whose spatial intensity course I(x) increases or decreases rapidly are identified as retroreflectors, and light surfaces whose spatial intensity course I(x) gradually and continuously increases or decreases are identified as vehicle lights.

10. A method according to claim 7, wherein a gradient of an intensity dI/dx in an image direction is calculated in an area around a light surface, and
wherein a nearly constant course of the gradient of the intensity dI/dx in an area of the light surface is identified as vehicle light, or
wherein a narrow and distinct maximum of the gradient of the intensity dI/dx in the area of the light surface is identified as retroreflector.

11. An apparatus for distinguishing between retroreflectors and vehicle lights in the dark in the surroundings of a vehicle comprising an image recording device and an evaluation unit, wherein the evaluation unit evaluates the image data detected by the image recording device by a method corresponding to claim 7.
